(19) United States
(12) Patent Application Publication
(10) Pub. No.: US 2009/0142434 A1
(43) Pub. Date: Jun. 4, 2009

(54) APPARATUS FOR IN-MOLD-DECORATION

(75) Inventor: Chung-Chi Tseng, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/957,503

(22) Filed: Dec. 17, 2007

(30) Foreign Application Priority Data
Nov. 29, 2007 (CN) 200710202765.3

(51) Int. Cl. B29C 45/17; B29C 45/14

(52) U.S. Cl. 425/126.1; 425/589

(57) ABSTRACT

An apparatus for in-mold-decoration includes a mold, a transport, and at least one movable element. The mold includes a male mold and a female mold. The transport is used for transporting a foil into the mold between the male mold and the female mold. The at least one movable element is positioned between the male mold and the female mold, for defining an injection space together with the female mold and the male mold.

### BACKGROUND

1. Field of the Invention

The present invention generally relates to molding apparatuses. Particularly, the present invention relates to a mold apparatus for in-mold-decoration.

2. Description of Related Art

A common molding apparatus for In-Mold-Decoration (IMD) is illustrated in FIG. 1. The molding apparatus includes a transport 102, a foil 104, a mold including a female mold 106 and a male mold 108.

The transport 102 includes two rollers that are disposed at opposite sides of the mold, for transporting the foil 104 into the mold between the female mold 106 and the male mold 108.

The female mold 106 defines a cavity 110 in a side thereof facing the male mold 108. A plurality of air discharging holes 112 is defined in the female mold 106 from the cavity 110 to the other side of the female mold 106. The air discharging holes 112 are connected to a vacuum pump (not shown) for evacuating air from the cavity 110.

A protrusion 114 is protruded from the male mold 108 on the side thereof facing the female mold 106, and an injection opening 116 runs through the male mold 108 from the protrusion 114 to the other side thereof.

Referring to FIG. 2, the foil 104 is transported into the mold between the female mold 106 and the male mold 108. The vacuum pump evacuates air, through the air discharging holes 112, from a space bounded by the foil 104 and a surface of the cavity 110, therefore the foil 104 is tightly attached to the female mold 106. The male mold 108 moves relative to the female mold 106, and is locked with the female mold 106. The foil 104 is pressed in the mold, accordingly.

Popularly, due to the depth of the cavity 110, the foil 104 is often stretched to be firmly attached on the surface of the cavity 110. The foil 104 can be damaged or even broken if it is stretched excessively.

What is needed is to provide a molding apparatus in which a depth that the foil can be extended is controlled.

### SUMMARY

In one embodiment, an apparatus for in-mold-decoration includes a mold, a transport, and at least one movable element. The mold includes a male mold and a female mold. The transport is used for transporting a foil into the mold between the male mold and the female mold. The at least one movable element is positioned between the male mold and the female mold, for defining an injection space together with the female mold and the male mold.

Other advantages and novel features of the apparatus will become more apparent from the following detailed description of embodiments when taken in conjunction with the accompanying drawings, in which:

### BRIEF DESCRIPTION OF THE DRAWINGS

FIG. 1 is a sectional view of an apparatus for in-mold-decoration in a related art;

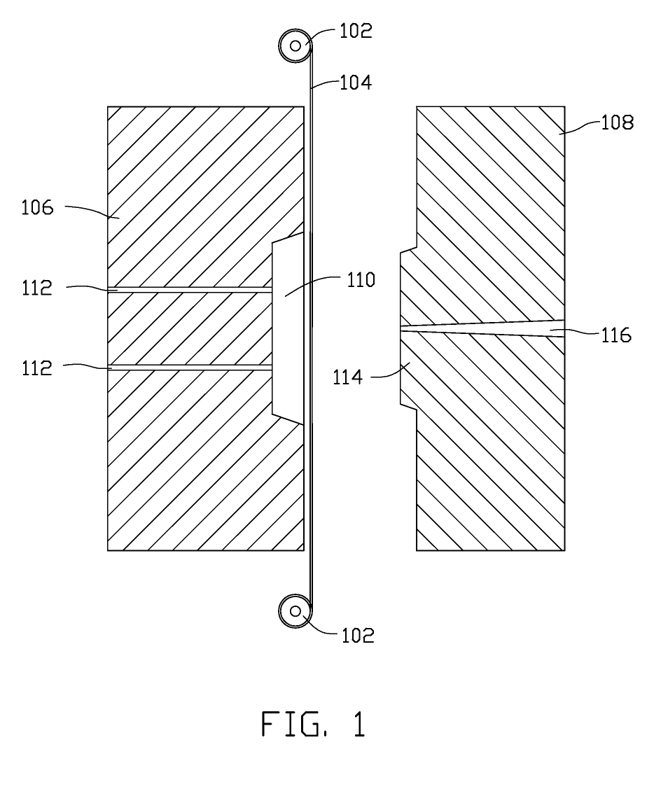

FIG. 2 is a sectional view of the apparatus of FIG. 1 in injection molding;

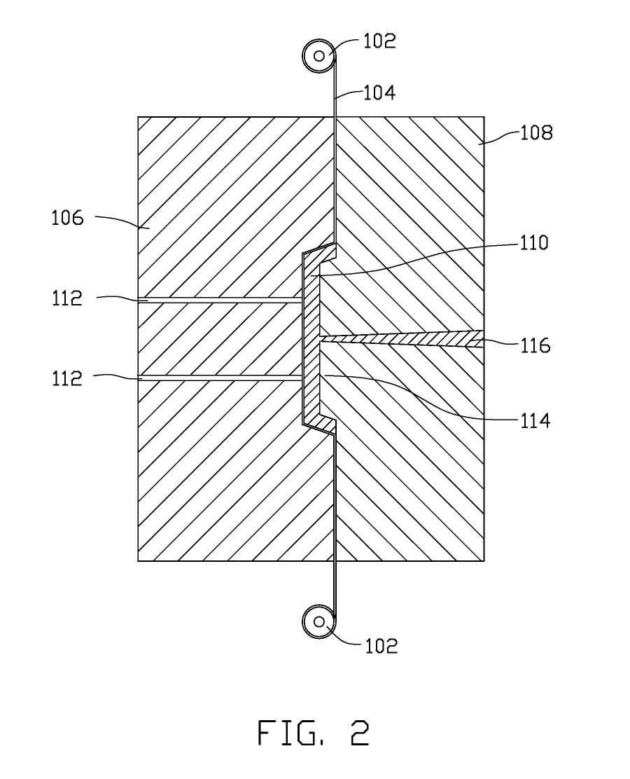

FIG. 3 is a sectional view of an apparatus for in-mold-decoration in accordance with an exemplary embodiment;

FIG. 4 is a sectional view of the apparatus of FIG. 3 during injection process; and

FIG. 5 is a sectional view of an apparatus for in-mold-decoration in accordance with another exemplary embodiment.

### DETAILED DESCRIPTION

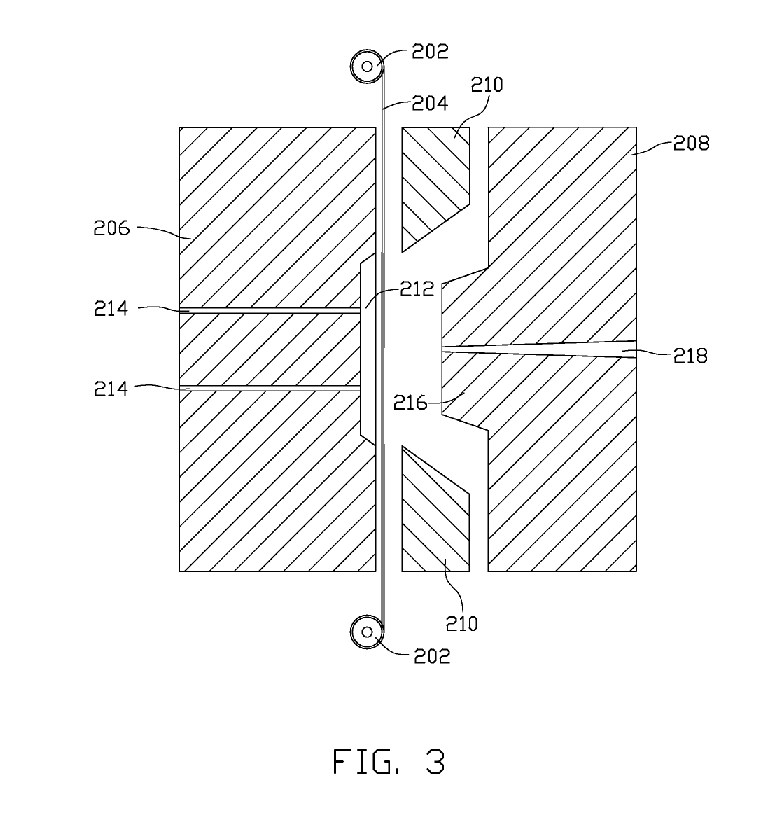

Referring to FIG. 3, an apparatus for In-Mold-Decoration (IMD) includes a transport 202, a foil 204, a mold including a female mold 206 and a male mold 208, and at least one movable element 210.

The transport 202 is used for transporting the foil 204 into the mold between the female mold 206 and the male mold 208. In this embodiment, the foil 204 includes a printed layer (not shown) attached thereon, the printed layer separates from the foil 204 after a product is molded.

The female mold 206 defines a cavity 212 in a side thereof facing the male mold 208, a plurality of air discharging holes 214 communicating the cavity 212 and the other side of the female mold 206 are defined in the female mold 206. The air discharging holes 214 are connected to a vacuum pump (not shown), for evacuating air from the cavity 212.

The male mold 208 protrudes towards the female mold to form a protrusion 216 facing the cavity 212. An injection opening 218 is defined through the male mold 208 from the protrusion 216 thereof to the opposite side thereof.

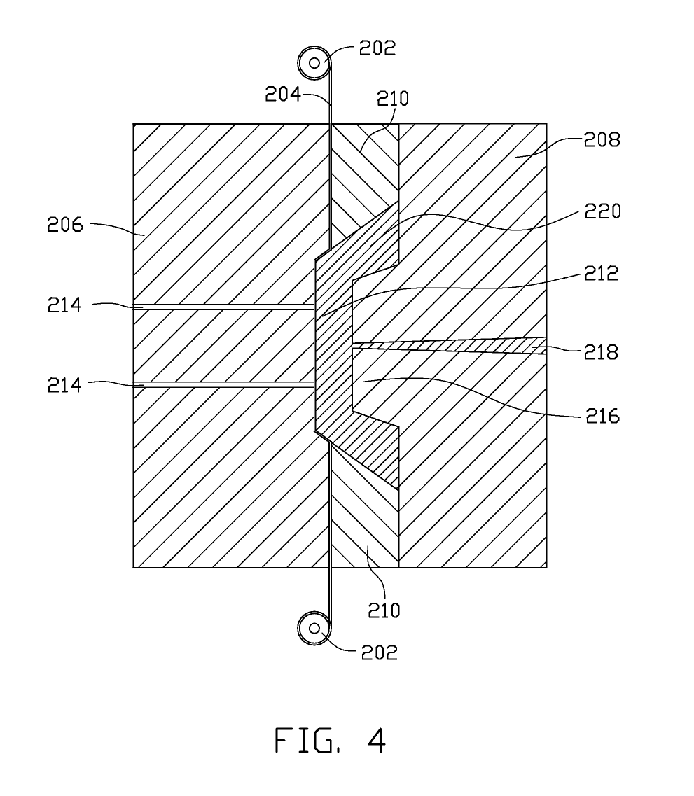

The movable element 210 is positioned between the female mold 206 and the male mold 208. The movable element 210 is located between the female mold 206 and the male mold 208, thereby defining an injection space 220 (as shown in FIG. 4) together with the surface of the cavity 212, the protrusion 216 and parts of the male mold 208 around the protrusion 216. The foil 204 is pressed by the movable element 210 to the female mold 206. A thickness of the movable element 210 is determined by a height of a product to be molded.

The movable element 210 can separably fixed on the male mold 208 through an elastic element (not shown) to keep a distance away from the male mold 208 in normal situations. As the male mold 208 is locked to the female mold 206, the movable element 210 is pressed on the female mold 206 with one side. The other side of the movable element 210 is resiliently depressed by the elastic element. Therefore, the movable element 210 is tightly sandwiched therebetween.

The movable element 210 can also be apart from the male mold 208 and the female mold 206, and driven by other mechanics (not shown). The movable element 210 is driven by the mechanics to move to a position between the female mold 206 and the male mold 208 as the mold is locked.

Referring to FIG. 4, the foil 204 is transported into the mold between the female mold 206 and the male mold 208. The movable element 210 and the male mold 208 move towards the female mold 206, thereby pressing the foil 204 to the female mold 206. The vacuum pump evacuates air from the space bounded by the foil 204 and the female mold 206, thereby tightly attaching the foil 204 to the surface of the cavity 212. After the movable element 210 is firmly sandwiched between the female mold 206 and the male mold 208, molten resin is injected into the injection space 220 through the injection opening 218, until the injection space 220 is filled. After the molten resin cools, the mold is unlocked to separate the female mold 206, the male mold 208, and the movable element 210. The printed layer that was previously attached to the foil 204 separates from the foil 204, adhering to the surface of the molded product. The transport 202 is operated to transport the foil 204 out of the mold, and transport the foil 204 with another printed layer thereon into the mold.

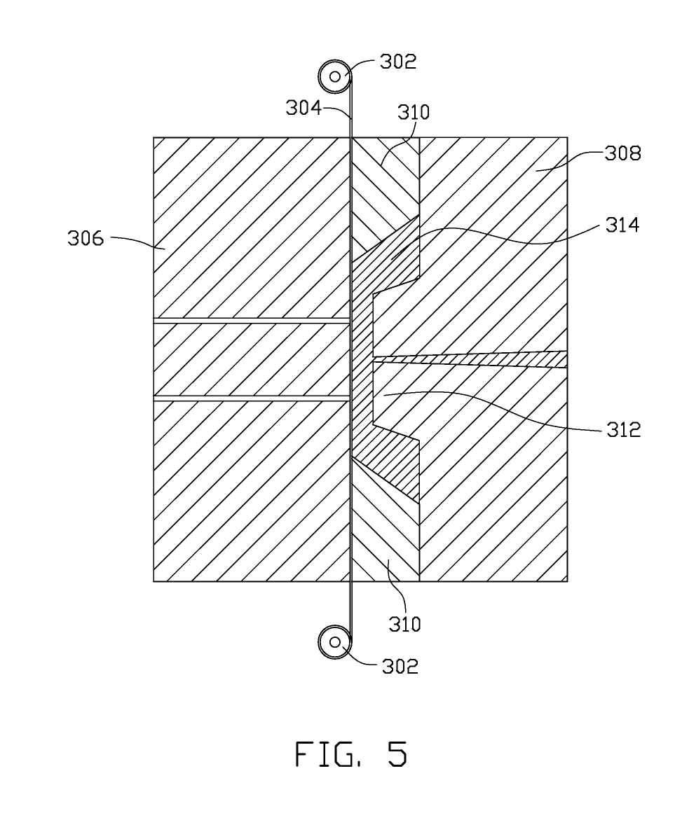

Referring to FIG. 5, the apparatus for IMD is similar to the apparatus as shown in FIG. 3. The apparatus includes a transport 302, a foil 304, a mold including a female mold 306 and a male mold 308. The male mold 308 protrudes towards the female mold 306 to form a protrusion 312, but the female mold 306 does not define a cavity therein. A movable element 310 is positioned between the female mold 306 and the male mold 308, for defining an injection space together with the foil 304, the protrusion 312, and part of the male mold 308 that is around the protrusion 312. Therefore, the foil 304 is not stretched when the vacuum pump evacuates air from the space between the foil 304 and the female mold 306.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An apparatus for in-mold-decoration comprising:
a mold comprising a male mold and a female mold;
a transport for transporting a foil into the mold between the male mold and the female mold; and
at least one movable element being positioned between the male mold and the female mold, for defining an injection space together with the female mold and the male mold.

2. The apparatus as described in claim 1, wherein said at least one movable element presses the foil to the female mold as the male mold is locked with the female mold.

3. The apparatus as described in claim 1, wherein the female mold defines a cavity in a side thereof facing the male mold, a plurality of air discharging holes runs through the female mold connecting the cavity and the other side of the female mold.

4. The apparatus as described in claim 3, wherein the male mold protrudes toward the cavity, therefore forming a protrusion thereon.

5. The apparatus as described in claim 3, wherein the injection space is defined by the movable element, the male mold, and a surface of the cavity.

6. The apparatus as described in claim 1, wherein the movable element is attached to the male mold and the female mold at opposite sides thereof.

7. The apparatus as described in claim 1, wherein the movable element is separably fixed to the male mold.

8. An apparatus for in-mold-decoration comprising:
a mold comprising a male mold and a female mold, the mold forming an injection space as the male mold is locked with the female mold;
a movable element positioned between the male mold and the female mold, for being pressed between the male mold and the female mold to bound and airproof the injection space; and
a foil firmly pressed to the female mold by the movable element as the male mold is locked with the female mold.

9. The apparatus as described in claim 8, wherein the female mold defines a cavity in a side thereof facing the male mold.

10. The apparatus as described in claim 9, wherein the male mold protrudes toward the cavity, therefore forming a protrusion thereon.

11. The apparatus as described in claim 10, wherein the injection space is bounded by the movable element, a surface of the cavity of the female mold, the protrusion and parts around the protrusion of the male mold.

12. The apparatus as described in claim 8, wherein a plurality of air discharging holes runs through the female mold, for connecting the cavity and the other side of the female mold.

13. The apparatus as described in claim 8, wherein a protrusion protrudes from the male mold toward the female mold, the injection space is defined by the movable element, a side of the female mold facing the male mold, the protrusion and parts around the protrusion of the male mold.
